(19) United States
(12) Patent Application Publication
(10) Pub. No.: US 2007/0019630 A1
(43) Pub. Date: Jan. 25, 2007

(54) Communication system, server apparatus and data terminal apparatus

(76) Inventors: Shinichi Kashimoto, Ome-shi (JP); Yasumasa Sasaki, Tachikawa-shi (JP); Shigeru Fukazawa, Hachioji-shi (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/475,633

(22) Filed: Jun. 26, 2006

(30) Foreign Application Priority Data
Jun. 30, 2005 (JP) 2005-192672

(51) Int. Cl. H04L 12/66

(52) U.S. Cl. 370/352

(57) ABSTRACT

According to one embodiment, a server apparatus includes an acquiring unit to acquire more than one items of data reception address information included in a data area of a message from each data terminal in connecting the data terminals with one another, a specifying unit to specify address information to receive a data communication based on the data reception address information and address information of a destination of the message, and a notifying unit to notify instruction information to instruct that the address information should be used for the data communication to the data terminal.

### CROSS-REFERENCE TO RELATED APPLICATIONS

This application is based upon and claims the benefit of priority from Japanese Patent Application No. 2005-192672, filed Jun. 30, 2005, the entire contents of which are incorporated herein by reference.

### BACKGROUND

1. Field

One embodiment of the invention relates to a communication system, a server apparatus and a data terminal apparatus, which connects a server apparatus to a plurality of telephone exchange apparatuses, connected via leased lines one another, via communication channels to enable handling a video signal and computer data in addition to a voice signal and links data communication connections between data terminals connected to the server apparatus with call connections between phone terminals.

2. Description of the Related Art

In recent years, for instance, an enterprise having a plurality of branches and business offices has used mainly a multi-node system, in which telephone exchange apparatuses such as private branch exchanges (PBXs) or key telephone main apparatuses are installed respectively in each branch or business office so as to connect among the telephone exchange apparatuses via leased lines. Such system can perform inter-extension communications among different telephone exchange apparatuses and office line transmissions and receptions of calls via the different telephone exchange apparatuses as well as can perform inter-extension communications and office line transmissions and receptions of calls through a public network, etc., for each telephone exchange apparatus.

Recently, a system which connects a server with data terminals such as television phone terminals and personal computers connected thereto to the telephone exchange apparatuses via transmission paths to link a voice communication system using the telephone exchange apparatus with a data communication system using the server is propose (for instance, Jpn. Pat. Appln. KOKAI Publication No. H8-321889).

In the meantime, an application of a system to link the multi-node system with the data communication system by the server is also mightily desired. Furthermore, a service to link data communication connections between data terminals with call states of phone terminals is also strongly desired for the multi-node system. A system a side-by-side type of the telephone exchange apparatus and the server given above, however, starts sessions between the data communication terminals to share data between the data terminal by linking with the call states of the phone terminals. And the application of the server to the multi-node system and an additional service such as a television conference has been still in an examination state and has not been realized yet.

In the meanwhile, the linkage between the voice communication system using the foregoing multi-node system and the data communication system using the server causes a necessity of an examination for the below-mentioned countermeasure.

In other words, it is predicted for the aforementioned multi-node system will become a large-scaled system in the future. However, in general, having been used a personal computer as the server in the multi-node system, the capacity of the personal computer results in a limitation of the number of the data terminals possible to be housed in the server. Therefore, the multi-node system is poor at its expandability and impossible to correspond flexibly to a change in the system such as an expansion of the number of the telephone exchange apparatuses.

In the foregoing server, it is supposed for housing the data terminals to house them via a network address translator (NAT) router. The NAT router uses one IP address assigned for a connection in advance to translate a private address into a global address and sends it as an outgoing origin IP address, then, translates a global address of a destination IP address supplied in receiving into the private address. Therefore, the multi-node system requires counter measure for the NAT router.

Further, the multi-node system desires to link other communication services with the phone terminals in addition to a video communication service such as a television conference linked with the phone terminals.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary schematic configuration view showing a visual communication system (VCS) regarding the invention;

FIG. 2 is an exemplary block diagram showing a functional configuration of a VCS server regarding a first embodiment of the invention;

FIG. 3 is an exemplary view showing an example of a storage content of a shared information management table shown in FIG. 2;

FIG. 4 is an exemplary view showing an example of a storage content of an individual information management table shown in FIG. 2;

FIG. 5 is an exemplary view showing an example of a storage content of an individual information management table similarly shown in FIG. 2;

FIG. 6 is an exemplary schematic sequence view showing transmission/reception operations of information among a data terminal, the VCS server and a storage unit in registering in the VCS server by associating data terminals with phone terminals in the first embodiment FIG. 1 of the invention;

FIG. 7 is an exemplary schematic sequence view showing transmission/reception operations of information between one group of the phone terminal, a main apparatus, the VCS server and the data terminal and the other group thereof in executing visual communication control in the first embodiment of the invention;

FIG. 8 is an exemplary detailed sequence view showing transmission/reception operations of information among the VCS servers and the data terminals in executing the visual communication control in the first embodiment of the invention;

FIG. 9 is an exemplary block diagram showing a functional configuration of a VCS server in a second embodiment of the invention;

FIG. 10 is an exemplary schematic sequence view showing transmission/reception operations of information between one group of a phone terminal, a main apparatus, the VCS server and a data terminal and the other group thereof in establishing sessions between the data terminals under different NAT routers in the second embodiment of the invention;

FIG. 11 is an exemplary detailed sequence view showing transmission/reception operations of information among the VCS servers and the data terminals in establishing sessions between the data terminals under different NAT routers in the second embodiment of the invention;

FIG. 12 is an exemplary flowchart showing a control processing procedure of the VCS server in the second embodiment in the invention;

FIG. 13 is an exemplary flowchart showing a control processing procedure of the data terminal in the second embodiment of the invention;

FIG. 14 is an exemplary schematic sequence view showing transmission/reception operations of information between one group of the phone terminals, main apparatuses, VCS servers and data terminals in establishing sessions between the data terminals under the same NAT router in the second embodiment of the invention;

FIG. 15 is an exemplary detailed sequence view showing transmission/reception operations of information among the VCS servers and the data terminals in establishing sessions between the data terminals under the same NAT router in the second embodiment of the invention;

FIG. 16 is an exemplary view showing an example of global IP addresses assigned to the NAT routers in the second embodiment of the invention;

FIG. 17 is an exemplary schematic sequence view showing transmission/reception operations of information between one group of a phone terminal, a main apparatus, a VCS server and a data terminal(s) and the other group thereof in executing visual communication control in a third embodiment of the invention;

FIG. 18 is an exemplary detailed sequence view showing transmission/reception operations of information among the VCS servers and the data terminals in executing the visual communication control in the third embodiment of the invention;

FIG. 19 is an exemplary flowchart showing a control processing procedure of the VCS server in the third embodiment of the invention;

FIG. 20 is an exemplary block diagram showing a functional configuration of a data terminal in a fourth embodiment of the invention;

FIG. 21 is an exemplary detailed sequence view showing transmission/reception operations of information among the VCS servers and the data terminals in establishing sessions between the data terminals under different NAT routers in the fourth embodiment of the invention;

FIG. 22 is an exemplary flowchart showing a control processing procedure of the data terminal in the fourth embodiment in the invention; and

FIG. 23 is an exemplary detailed sequence view showing transmission/reception operations of information among the VCS servers and the data terminals in establishing sessions between the data terminals under the same NAT router in the fourth embodiment of the invention.

### DETAILED DESCRIPTION

Various embodiments according to the invention will be described hereinafter with reference to the accompanying drawings. In general, according to one embodiment of the invention, a communication system, comprising: a first server apparatus to receive call information indicating call states of a plurality of phone terminals from at least one telephone exchange among a plurality of telephone exchanges executing exchange processing among a plurality of phone terminals, and link data communication connections at data terminals associated respectively with the plurality of phone terminals; a second server apparatus which is connected to the first server apparatus via a communication network and has the same function as that of the first server apparatus; a first memory which is commonly provided for the first and the second server apparatuses and stores a first management table associating first identification information assigned to the plurality of phone terminals, third information

least a part of items of second identification information assigned to a plurality of phone terminals belonging to the first server apparatus and third identification information to become at leas a part of items of second identification information assigned to a plurality of data terminals belonging to the second server apparatus with one another; a second memory which is provided for the first server apparatus and stores a second management table associating the third identification information belonging to the first server apparatus with fourth identification information to become information deferent from the third identification information out of the second identification information; a third memory which is provided for the second server apparatus and stores a third management table associating the third identification information belonging to the second server apparatus with the fourth identification information; and a controller which refers to the third identification information corresponding to a phone terminal of a request origin from the first management table, and connects among data terminals corresponding respectively to a plurality of phone terminals to be connected, based on the referred third identification information and fourth identification information corresponding to the third identification information stored in at least one of the second and the third management tables, in the first and the second server apparatuses in occurring a connection request.

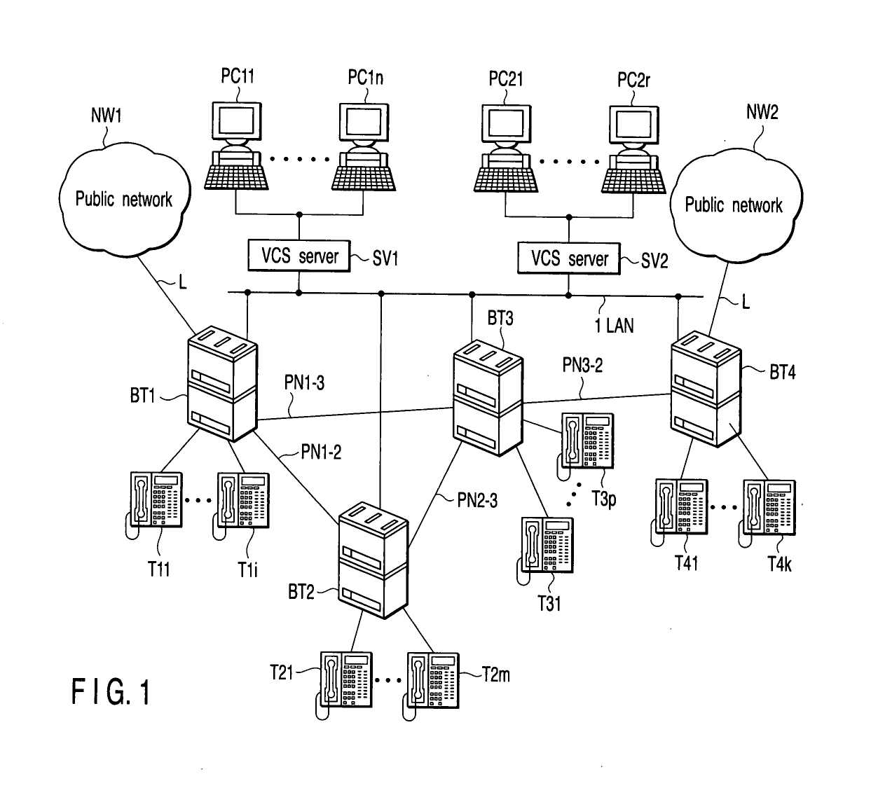

FIG. 1 is the exemplary schematic configuration view showing the visual communication system (VCS) regarding the invention.

The VCS has, as shown in FIG. 1, main apparatuses BT1 to BT4 and connects the main apparatuses BT1-BT4 one another by means of leased lines PN (PN1-2, PN1-3, PN2-3 and PN3-4). The main apparatuses BT1-BT4 house phone terminals T11-TT1i, T21-T2m, T31-T3p and T41-T4k via extension lines, respectively. The main apparatuses BT1 and BT4 are connected to public networks NW1 and NW2 via office lines L, respectively. That is, the main apparatuses BT1 and BT4 perform exchange connections among each phone terminal T11-T1i, T21-T2m, T31-T3p and T41-T4k, respectively, and among the phone terminal T11-T1i, T21-T2m, T31-T3p, T41-T4k and the public networks NW1 and NW2, respectively.

The main apparatuses BT1-BT4 are connected to a local area network (LAN) 1. VCS servers SV1 and SV2 are connected to the LAN 1. The VCS servers SV1 and SV2 house a plurality of data terminals PC11-PC1n and PC21-PC2r, respectively. The data terminals PC11-PC1n and PC21-PC2r are constituted of general-purpose personal computers, respectively, and operate in association with each phone terminals T11-T1i, T21-T2m, T31-T3p and T41-T4k, respectively.

The VCS servers SV1 and SV2 execute additional functions to each main apparatus BT1-BT4 by sharing with each other, and process media information such as videos.

(First Embodiment)

The first embodiment of the present invention is related to the above-mentioned VCS servers SV1 and SV2.

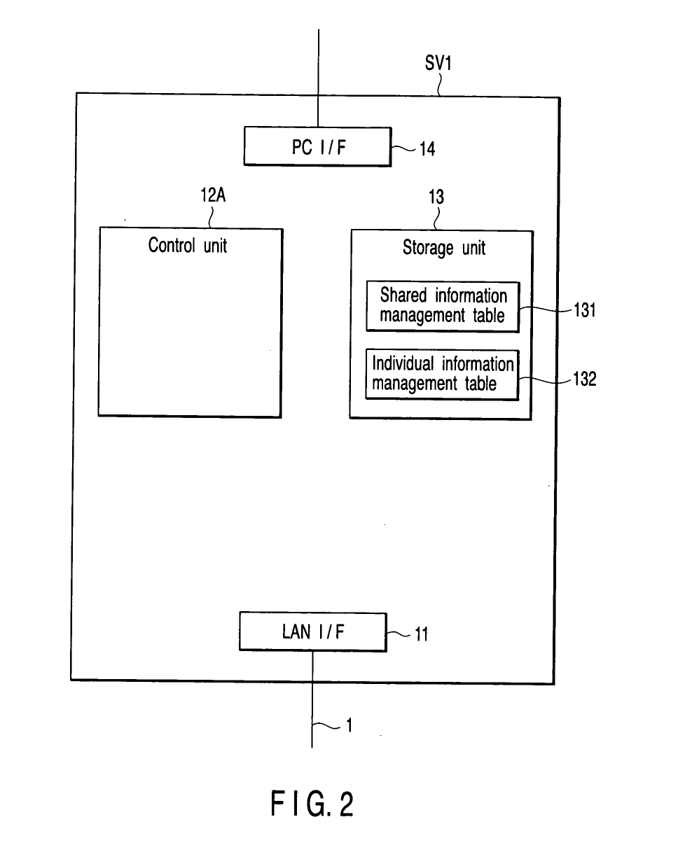

FIG. 2 is the block diagram showing the functional configurations of the VCS servers SV1 and SV2. Here, the VCS servers SV1 and SV2 have the same functions with each other, so that the VCS server SV1 will be described as a representative of them.

The VCS server SV1 includes a LAN interface unit 11, a control unit 12A, a storage unit 13 and a PC interface unit 14. Out of these units, the LAN interface unit 11 conducts interface processing to and from the LAN 1.

The PC interface unit 14 performs interface processing to and from each data terminal PC11-PC1n.

The storage unit 13 stores routing information, etc., necessary for connection control by the control unit 12A. The storage unit 13 is further includes a shared information management table 131 and an individual information management table 132.

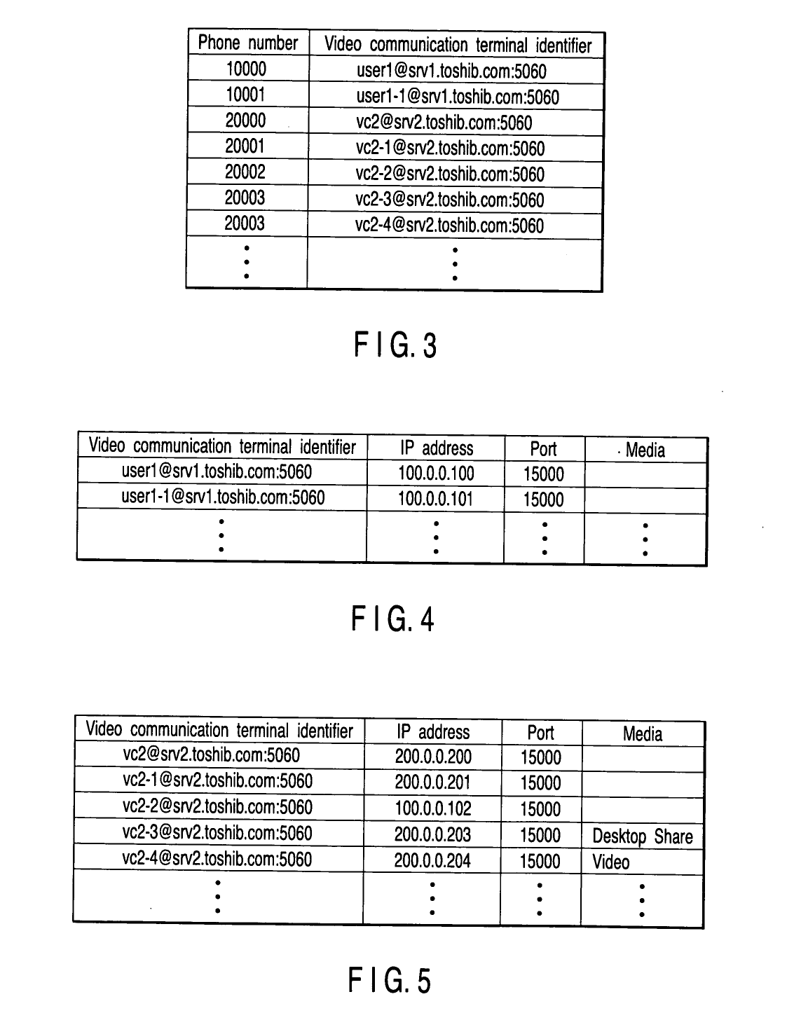

The shared information management table 131 stores, as shown in FIG. 3, data indicating corresponding relationships between phone numbers respectively assigned to the phone terminals T11-T1i, T21-T2m, T31-T3p and T41-T4k and vide communication terminal identifiers constituting of a part of items of identification information and to be respectively assigned to the data terminals PC11-PC1n and PC21-PC2r.

The individual information management table 132 stores, in the case of VCS server SV1, as shown in FIG. 4, data indicating corresponding relationships between the vide communication terminal identifiers constituting phone numbers assigned respectively to the phone terminals T11-T1i, T21-T2m, T31-T3p, and T41-T4k and data indicating IP addresses, port numbers and media names to become the remaining of the identification information assigned to the data terminals PC11-PC1n. In the case of the VCS server SV2 the individual information management table 132 stores, as shown in FIG. 5, data indicating corresponding relationships between the video communication terminal identifiers each assigned to the data terminals PC21-PC2r, and IP addresses, port numbers and media names that are the remaining of the identification information assigned to the data terminals PC21-PC2r.

On the other hand, the control unit 12A refers to the video communication terminal identifiers corresponding to the terminals T11 and T21 of request origins from the shared information management table 131 at issuing connection requests in addition to a control function with respect to state management for the data terminals PC11-PC1n and with respect to association operations between the data terminals PC11-PC1n and the phone terminals T11-T1i, T21-T2m, T31-T3p and T41-T4k. And then, the control unit 12A specifies the data terminals PC11 and PC21 associated with the phone terminals T11 and T21 on the basis of the referred video communication terminal identifiers and the IP addresses, port numbers and media names corresponding to the corresponding video communication terminal identifiers stored in the individual information management table 132 to establish sessions between the data terminals PC11 and PC21. Belonging to the server SV2, the data terminal PC21 transfers a connection instruction including the video communication terminal identifiers to the VCS server SV2 via the LAN 1.

Next to this, operations in the above-mentioned configuration will be explained.

(Registration Operations)

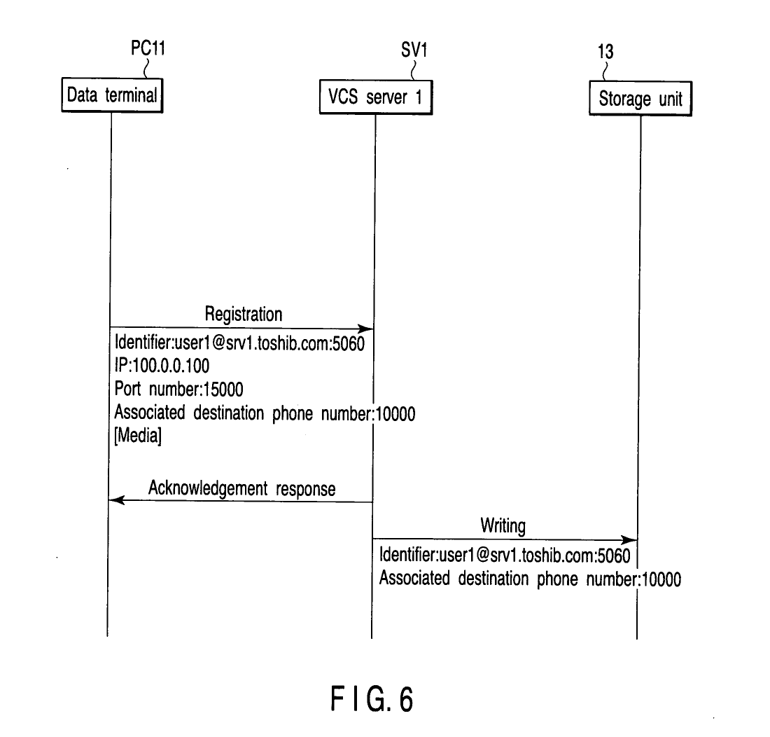

FIG. 6 shows the schematic sequence view showing transmission/reception operations of information among the data terminal PC11, VCS server SVl and storage unit 13 in registering, for example, the data terminal PC11 and the phone terminal 11 in the VCS server SV1 by associating them with each other.

To associate the data terminal PC11 with the phone terminal T11, the data terminal PC11 transmits a registration request, including the phone number of the phone terminal T11, a video communication terminal identifier (user1@srv1.toshib.com:5060), an IP address (100.0.0.100) and a port number (15000) assigned to the data terminal PC11, toward the VCS server SV1.

When receiving the registration request, the VCS server SV1 replies an acknowledgement response indicating the fact of the reception of the registration request to the data terminal PC11. Further, the VCS server SV1 records the phone number of the phone terminal T11 and the terminal identifier of the data terminal PC11 into the shared information table 131 of the storage 13 and records the terminal identifier, IP address and port number of the data terminal PC11 into the individual information table 132. (In this case, not being under the NAT, any communication with the NAT router is not made. One function of a UPnP has been widely used as functions to communicate with the NAT router, to acquire a “Global address”, to get a spare port number for use from the NAT router, etc.)

The present invention has supposed that one domain name (for example, srv1.toshib.com) is added to one VCS server SV1, a plurality of server functions of the invention operate with varying those port numbers on the physical single VCS server SV1 and a client registers the necessary identification information to each server to add a port number at the end of a terminal identifier. However, if only one server function operates on one VCS server SV1 and the port number used by the server function is 5060 of a default value, there is no need to add the port number at the last of the terminal identifier.

(Outgoing Operation from Phone Terminal T21 to Phone Terminal Tl1)

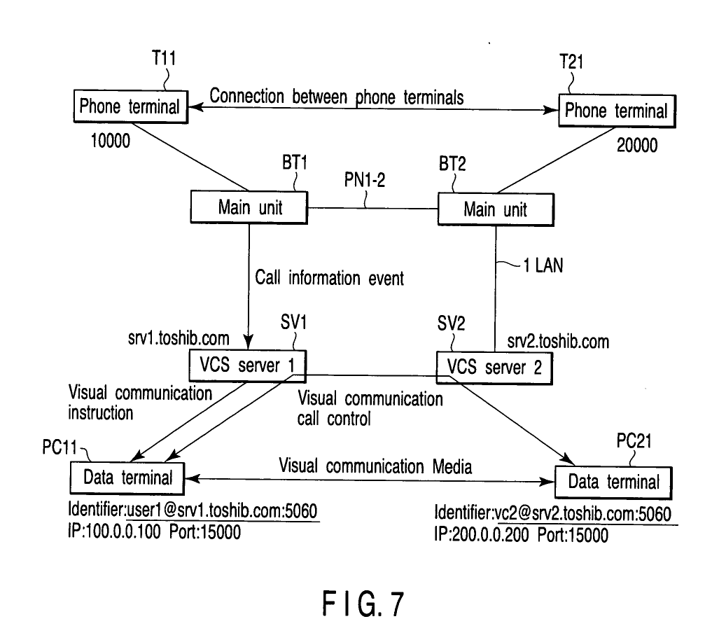

FIG. 7 shows a schematic sequence view showing transmission/reception operations of information between one group consisting of a phone terminal T11, a main apparatus BT1, a VCS server SV1 and a data terminal PC11 and the other group consisting of a phone terminal T21, a main apparatus BT2, a VCS server SV2, and a data terminal PC21, in executing visual communication control.

It is presumed that a user dials “10000” of the phone terminal T21 in order to make a communication with the user of the phone terminal T11. The phone terminal T21 then sends a communication establishment request signal to the main apparatus BT2. When receiving the request signal, the main apparatus BT2 transfers the request signal to the main apparatus BT1 via the leased line PN1-2 to have the main apparatus BT1 call the phone terminal T11 at an incoming destination. If the phone terminal T11 responds to this call, a communication link is formed between the phone terminals T11 and T21.

Thus, the user of the phone terminal T11 can make a communication to and from the user of the phone terminal T21.

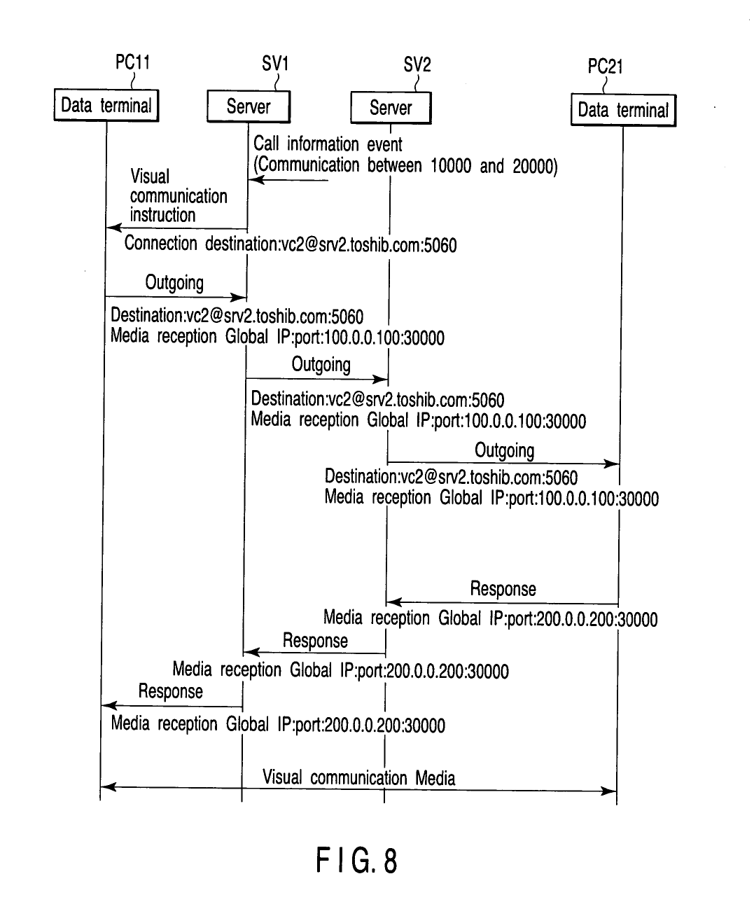

The VCS server SV1 then receives, as shown in FIG. 8, a call information event from the main apparatus BT1 of a node on an incoming side, refers to the shared information management table 131 and determines whether or not the video communication terminal identifier associated with the acquired phone partner information (phone number) is present in the shared information management table 131. Here, the video communication terminal identifier “user1@serv1.toshib.com:5060” corresponding to “10000” is present and the terminal identifier “vc2@srv2.toshib.com:5060” corresponding to “20000” is present, so that the VCS server SV1 refers to the individual information management table 132 to specify the data terminal PC11 on the basis of the IP address and the port number corresponding to the terminal identifier “user1@serv1.toshib.com:5060”. And the VCS server SV1 sends a visual communication instruction to the data terminal PC11. The data terminal PC11 then sends an outgoing message including the terminal identifier “vc2@srv2.toshib.com:5060” to the VCS server SV1.

The IP address and port number corresponding to the terminal identifier “vc2@srv2.toshib.com:5060” not being present, the VCS server SV1 transfers the outgoing message including the terminal identifier “vc2@srv2.toshib.com:5060” to the VCS server SV2 via the LAN 1.

When receiving the outgoing message, the VCS server SV2 determines the presence or absence of the IP address and port number corresponding to the terminal identifier “vc2@srv2.toshib.com:5060” by referring to the individual information management table 132. Here, the IP address and port number being present, the VCS server SV2 specifies the data terminal PC21 on the basis of the IP address and port number. At this moment, the VCS server SV2 sends a response message via the LAN 1 to the VCS serSV1.

In response to this, when the VCS server SV1 receives the response message, the session between the data terminal PC11 and the data terminal PC21 is established.

Consequently, the user of the phone terminal T21 becomes possible to automatically start a video communication with the data terminal PC11 by suing the data terminal PC21 only by operating the phone terminal T21.

As described above, in the first embodiment, a plurality of data terminals PC11-Pc1n and PC21-PC2r with the VCS servers SV1 and SV2 are associated, respectively, in advance. Thereby, to execute visual communications connecting between the data terminals PC11 and PC21 associated with each other in accordance with call states between the phone terminals T11 and T21, the VCS servers SV1 and SV2 can cooperate to execute efficiently the visual communications and flexibly cope with an expansion of a system scale.

And in the first embodiment, the VCS server SV1 divides information to distinguish a plurality of data terminals PC11-Pc1n and PC21-PC2r into the video communication terminal identifiers, IP addresses, port numbers and media names, the shared information management table 131 store only the phone numbers and the terminal identifiers and the individual information management table 132 stores only each terminal identifier, IP address, port number and media name of the data terminals PC11-PC1n of each user, respectively.

Accordingly, the first embodiment can extremely reduce the storage quality in the storage 13 accompanied with the expansion of the system scale, thereby, it can utilize a personal computer as the VCE server SV1. And also a personal computer is usable for the VCS server SV2.

(Second Embodiment)

A second embodiment of the present invention relates to the foregoing VCS servers SVI and SV2.

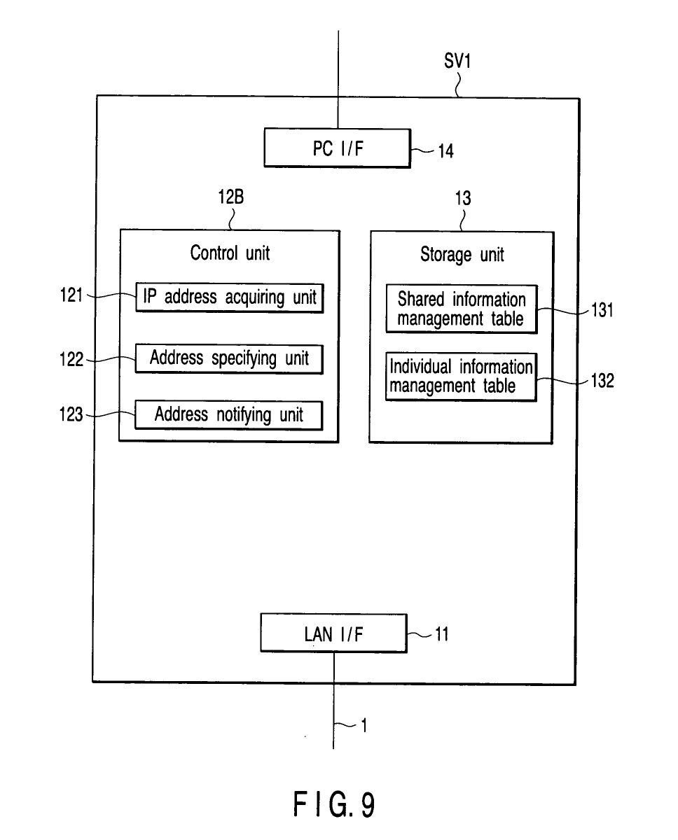

FIG. 9 is the block diagram showing the function configuration of the VCS server SV1. In FIG. 9, the same units as those of FIG. 2 will be put the same symbols thereto and the detailed explanation therefor will be eliminated.

A control unit 12B includes an IP address acquiring unit 121, an address specifying unit 122 and an address notifying unit 123 as functions regarding the invention.

The IP address acquiring unit 121 acquires one or more data receiving IP addresses and port numbers included in payload sections of messages sent from the data terminals PC12 and PC22, respectively, for example, in establishing the session between the data terminals PC12 and PC22.

The address specifying unit 122 determines whether or not the data communications between the data terminals are made via the NAT router on the basis of one or more data receiving IP addresses and port numbers included in the payload unit acquired by the acquiring unit 121 and the address information of the transmission destinations of the messages. And if the data communications are made via the NAT router, the address specifying unit 122 specifies the “Global address” itself, and otherwise, it specifies the “Local address” itself, respectively, out of one or more data receiving IP addresses and port numbers.

The address notifying unit 123 notifies instruction information to instruct that the address information specified by the address specifying unit 122 should be used in the data communications.

(Communications between Data Terminals under Different NAT routers)

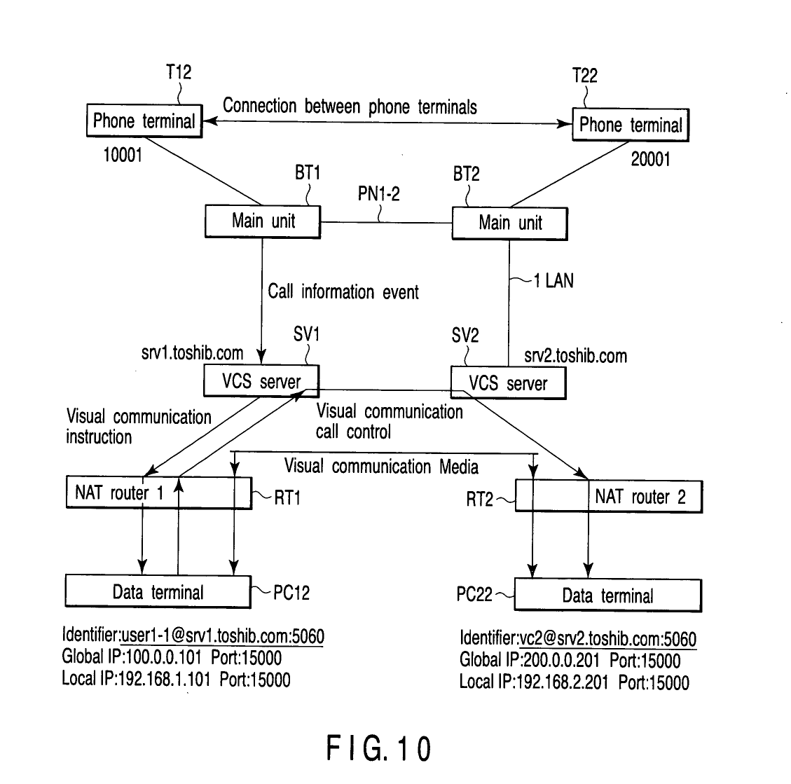

FIG. 10 is a schematic sequence view showing transmission/reception operations of information between one group composed of the phone terminals T11, main apparatuses BT1, VCS server SV1 and data terminal PC12 and the other group composed of the phone terminal T22, main apparatus BT2, VCS server SV2 and data terminal PC 22, in conducting the visual communication control.

In the phone terminal T22, it is supposed that the user operates a dial operation for “10001” in order to perform a communication with the user of the phone terminal T12. The phone terminal T22 then sends a communication establishment request signal to the main apparatus BT2. When receiving the request signal, the main apparatus BT2 transfers the request signal to the main apparatus BT1 via the leased line PN1-2 to have the main apparatus BT1 call the phone terminal T12 at the incoming destination. If the phone terminal T12 responds to this call, a communication link is formed between the phone terminals T12 and T22.

Thus, the user of the phone terminal T12 can make a communication to and from the user of the phone terminal T22.

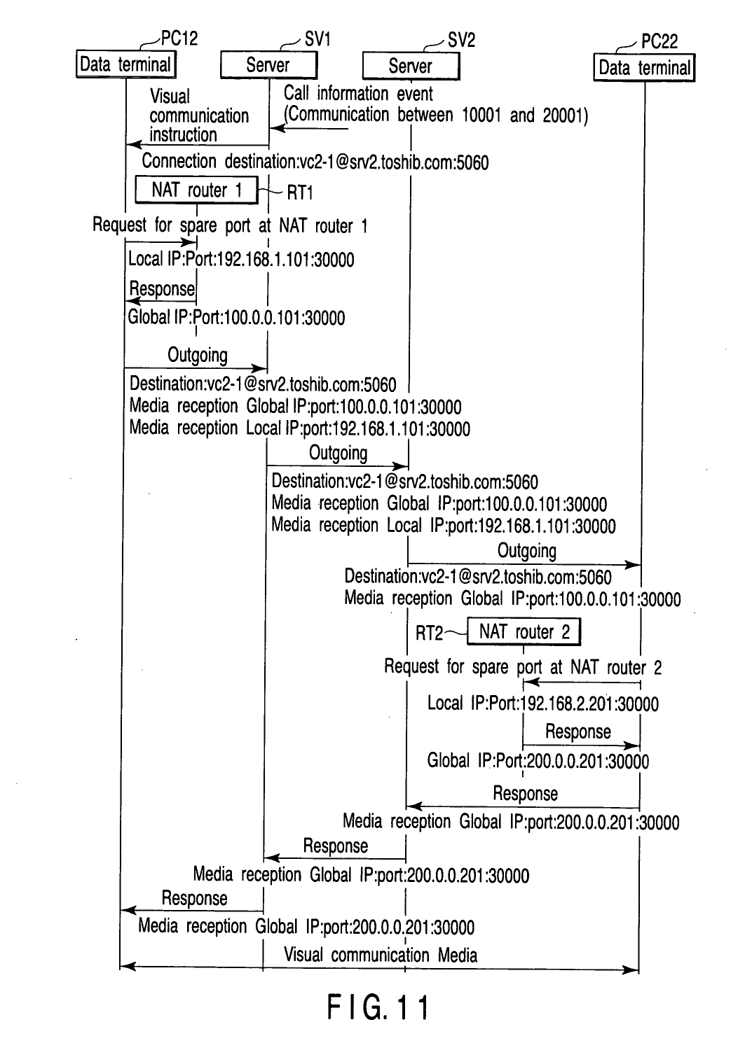

The VCS server SV1 then receives, as shown in FIG. 11, a call information event from the main apparatus BT1 of a node on an incoming side, refers to the shared information management table 131 and determines the presence or absence of the video communication terminal identifier associated with the acquired phone partner information (phone number) in the shared information management table 131. Here, the video communication terminal identifier “user1-1@srv1.toshib.com:5060” corresponding to the “10001” is present and the terminal identifier “vc2-1@srv2.toshib.com:5060” corresponding to “20001” is present, so that the VCS server SV1 refers to the individual information management table 132 to specify the data terminal. PC12 on the basis of the IP address and port number corresponding to the terminal identifier “user1-1@srv1.toshib.com:5060”. And the VCS server SV1 sends a visual communication instruction to the data terminal PC 12.

The data terminal PC12 which has received the visual communication instruction prepares a spare for a port to be used for a media reception from a NAT router RT1 and sets Global/Local IP: Port for the media reception to send an outgoing message to the VCS server SV1. Two items of data receiving address information that are Global IP: Port and Local IP: Port has been set in the payload section in the outgoing message.

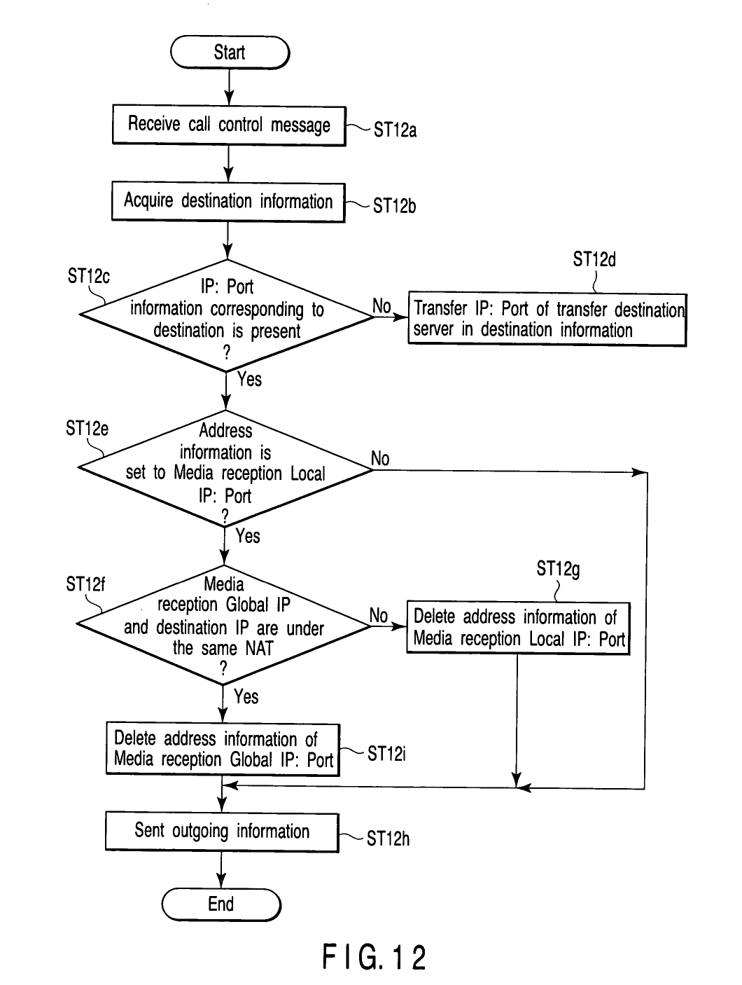

The VCS server SV1 then executes control processing sown in FIG. 12.

The VCS server SV1 firstly receives the outgoing message from the data terminal PC12 (block ST12a), acquires destination information included in the outgoing message (block ST12b), referees to the individual information management table 132 to determine whether the IP address and the port number corresponding to the terminal identifier “vc2-1@srv2.toshib.com:5060” are present or not (block 12c).

Here, the IP address and port number corresponding it not being present, the VCS server SV1 shifts from the block ST12c to a block ST12d to transfer the outgoing message including the terminal identifier “vc2-1@srv2.toshib.com:5060” to the VCS server SV2 via the LAN 1.

When receiving this outgoing message, the VCS server SV2 refers to the individual information management table 132 to determines whether the IP address and the port number corresponding to the “vc2-1@srv2.toshib.com:5060” are present or not. Here, they being present, the VCS server SV2 shifts to a block ST12e from the block ST12c to determine whether identification information is set to Media reception Local IP: Port or not.

Here, it has been set to the Media reception Local IP: Port, sp that the VCS server SV2 makes a shift from the block ST12e to a block ST12f to identify that an outgoing origin is under the NAT. The server SV2 then checks if the Media reception Global IP address and the destination Global IP address are under the same NAT.

Here, they are not under the same NAT, so that the VCS server SV2 shifts from the block ST12f to a block ST12g and deletes the identification information which has been set at the Media reception Local IP: Port to send an outgoing message to the data terminal PC22 therefrom (block ST12h).

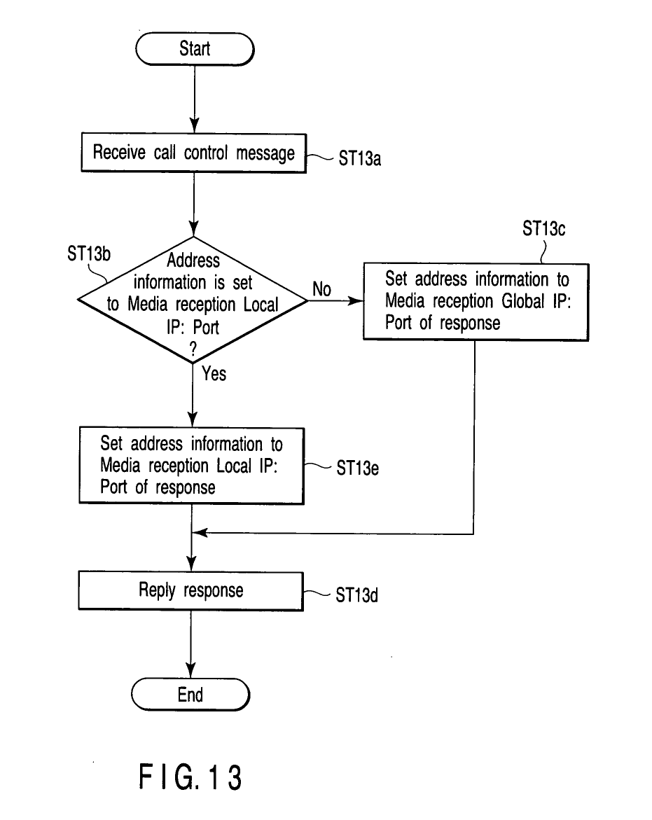

On the other hand, the data terminal PC22 performs control processing shown in FIG. 13.

At first, when the data terminal PC 22 receives an outgoing message from the VCS server SV2 (block ST 13a), the data terminal PC22 determines whether the identification information is set to the Media reception Local IP: Port or not (block ST13b). In this case, not having been set, the data terminal PC 22 sets a Global address acquired from a NAT router RT2 to a Media reception Global IP: Port of the response message (block ST13c).

After this, the data terminal PC22 sends the response message to the VCS server SV2 (block ST13d).

The VCS server SV2 then sends a response message to the VCS server SV1 via the LAN 1.

In response to this, when the VCS server SV1 receives the response message, the session between the data terminal PC12 and the data terminal PC22 is established.

Thus, the user of the phone terminal T22 becomes possible to automatically start the video communication to and from the data terminal PC12 by using the data terminal PC22 only by operating the phone terminal T22.

(Communication between Data Terminals under the Same NAT router)

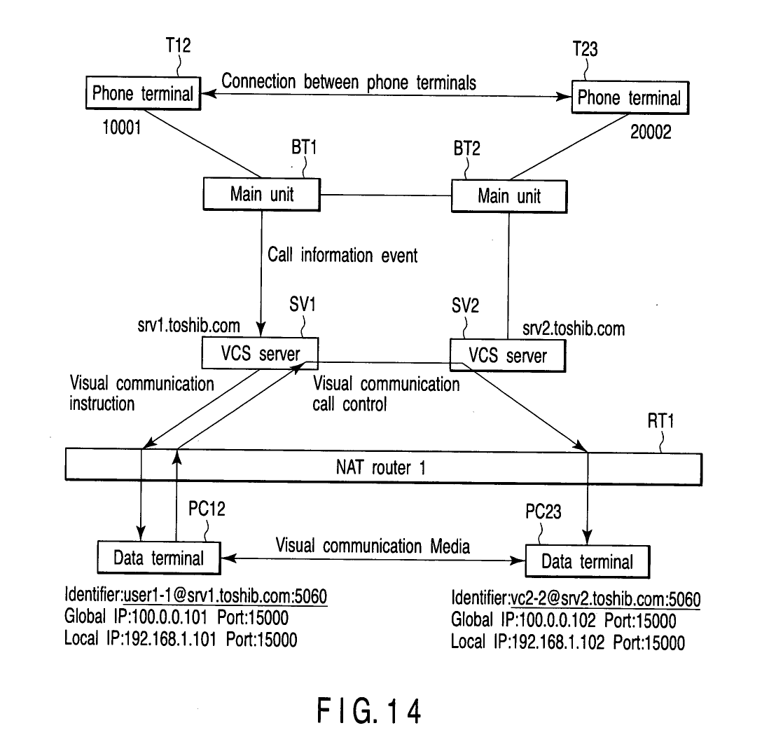

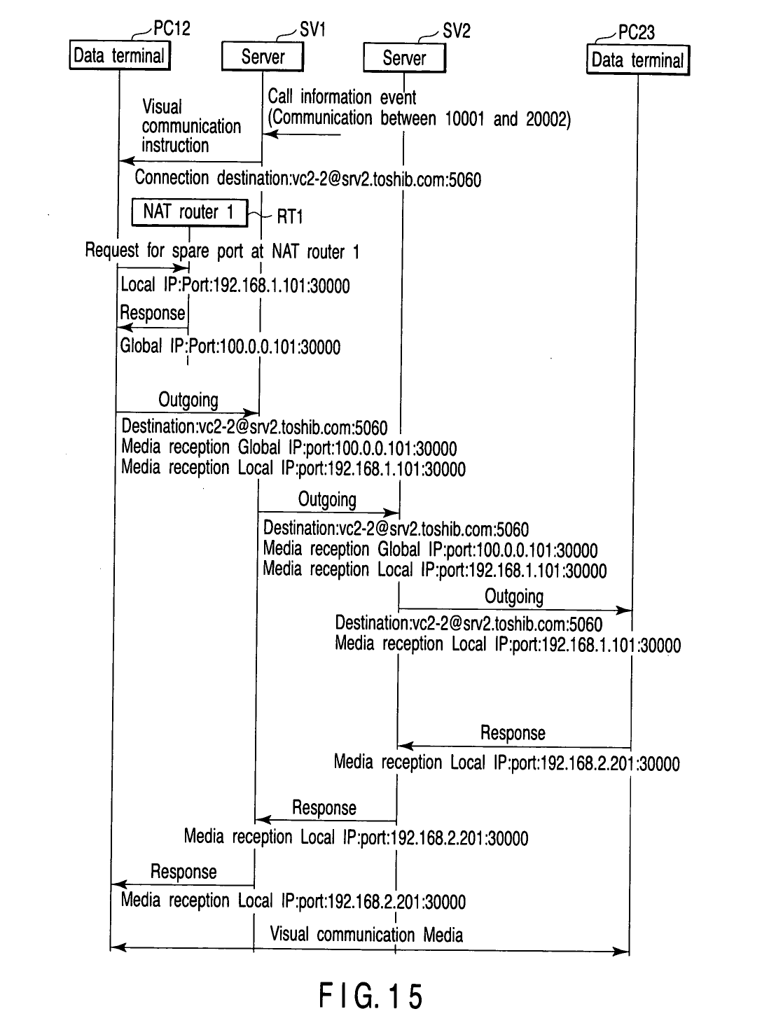

FIG. 14 is a schematic sequence view showing transmission/reception operations of information between one group composed of the phone terminals T12, main apparatuses BT1, VCS servers SV1 and data terminal PC12 and the other group composed of the phone terminal T23, main apparatuses BT2, VCS servers SV2 and data terminals PC23, in executing visual communication control. FIG. 15 is its detailed sequence view.

It is supposed that the user conducts a dial operation of “10001” at the phone terminal T23 so as to make a communication with the user of the phone terminal T12. The phone terminal T23 then sends the communication establishment request signal to the main apparatus BT2. When receiving the request signal, the main apparatus BT2 transfers the request signal to the main apparatus BT1 via the leased line PN1-2 to make the main apparatus BT 1 call the phone terminal T12 at the incoming destination. The response of the phone terminal T12 in response to this forms a communication link between the phone terminal T12 and the phone terminal T23.

The VCS server SV1 then receives, as shown in FIG. 15, a call information event from the main apparatus BT1 placed at a node on an incoming side and refers to the shared information management table 131 to determine whether or not the video communication terminal identifier associated with the acquired phone partner information (phone number) is present in the shared information management table 131. Here, the video communication terminal identifier “user1-1@srv1.toshib.com:5060” corresponding to the “10001” is present and the terminal identifier “vc2-2@srv2.toshib.com:5060” corresponding to “20002” is present, so that the VCS server SV1 refers to the individual information management table 132 to specify the data terminal PC12 on the basis of the IP address and port number corresponding to the terminal identifier “user1-1@srv1.toshib.com:5060”. And the VCS server SV1 sends a visual communication instruction to the data terminal PC12.

The data terminal PC12 which has received the visual communication instruction prepares a spare for a port to be used for the media reception from the NAT router RT1 and sets the Global/Local IP: Port for the media reception to send an outgoing message to the VCS server SV1.

The VCS server SV1 then receives the outgoing message from the data terminal PC12, acquires the destination information included in the outgoing message and refers to the individual information management table 132 to determine whether or not the IP address and the port number corresponding to the “vc2-2@srv2.toshib.com:5060”.

Here, they not being present, the VCS server SV1 transfers the outgoing message including the terminal identifier “vc2-2@srv2.toshib.com:5060” to the VCS server SV2 via the LAN 1.

When receiving the outgoing message, the VCS server SV2 determines the presence or absence of an IP address “100.0.0.102” and a port number “15000” corresponding to the terminal identifier “vc2-2@srv2.toshib.com:5060”, by referring to the individual information management table 132. Here, they being present, the VCS server SV 2 determines whether or not identification information is set to the Media reception Local IP: Port.

In this case, the identification information being set to the Media reception Local IP: Port, the VCS server SV2 identifies that the originator is under the control of the NAT and checks if the Media reception Global IP address of the outgoing message and the Global IP address of the destination are under the same NAT router.

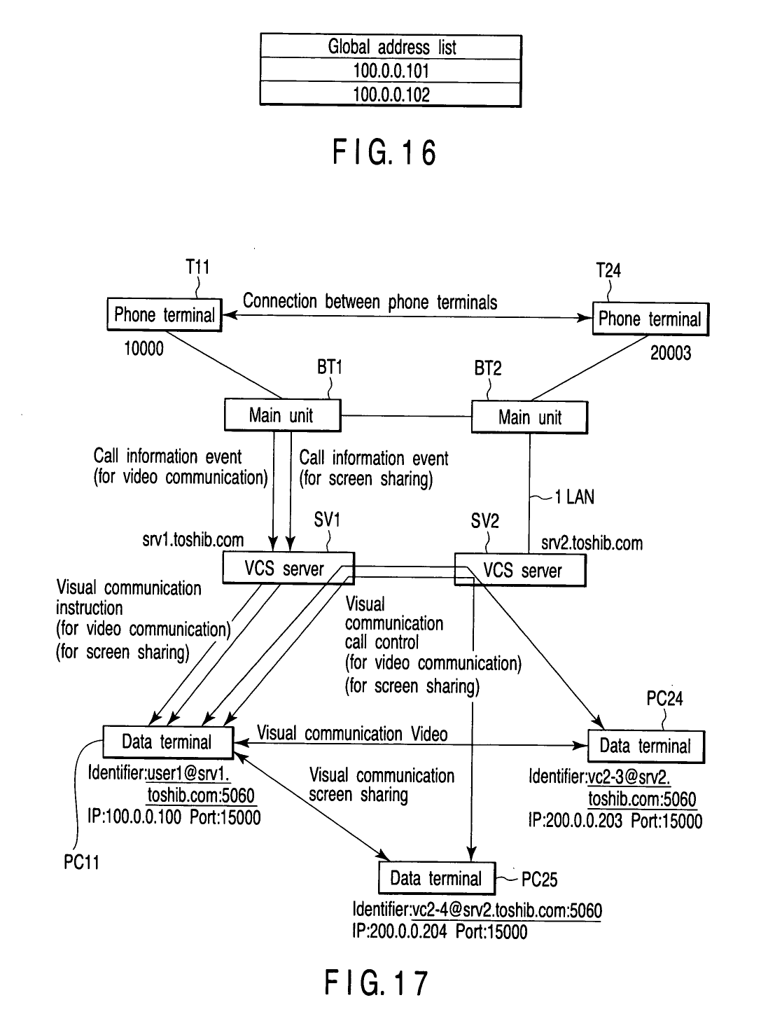

Here, as shown in FIG. 16, since the Global addresses assigned to the NAT router RT1 are “100.0.0.101” and “100.0.0.102”, the VCS server SV2 sifts from the block ST12f to a block ST12i and deletes the identification information set to the Media reception Global IP: Port to send an outgoing message to the data terminal PC23.

The data terminal PC 23 then determines whether or not the value is set to the Media reception Local IP: Port in the received outgoing message. In this case, the identification information is set thereto, the data terminal PC23 sets its own Local address to the Media reception Local IP: Port of the response message (block ST13e).

After this, the data terminal PC23 sends a response message to the VCS server SV2 via the LAN 1.

The VCS server SV2 then sends a response message to the VCS server SV1 via the LAN 1.

In response to this, when the VCS server SV 1 receives the response message, a session between the data terminal PC12 and the data terminal PC 23 is established.

Thus, the user of the phone terminal T23 becomes possible to automatically start a video communication to and from the data terminal PC12 by using the data terminal PC23 only by operating the phone terminal T23.

In the second embodiment like above, each VCS server SV1 and SV2 acquires two items of data receiving address information that are Global IP: Port and Local IP: Port which are set in payload sections of outgoing messages from the data terminals PC 12 and PC22 to be connected thereto, respectively, and determines whether or not data communications between the data terminals are performed via the NAT router on the basis of one or more data reception IP addresses and port numbers included in the payload sections and the address information of the destinations of the outgoing messages. And if the data communications are performed via the NAT router, each VCS server SV1 and SV2 sends the outgoing message with the Local IP: port deleted therefrom to the data terminal PC22 that is the destination. And otherwise, each VCS server SV1 and SV2 sends the outgoing message with the Global IP: Port deleted therefrom to the data terminal PC22 that is the destination.

Accordingly, the VCS regarding the second embodiment can utilize the existing data terminals as they are without having to add new functions to the data terminals PC12 and PC22 and without having to pay attentions to the presence or absence of the NAT routers RT1 and RT2 on the user sides of the data terminals PC12 and PC22. Thereby, the VCS can implement data communication connections between the data terminals PC12 and PC22 associated with each other in linking with the call connection between the phone terminals T12 and T22, by suppressing the costs of the whole VCS as much as possible.

(Third Embodiment)

The third embodiment of the present invention relates to the aforementioned VCS servers SV1 and SV2 which support one-to-multiple associations between telephone sets and video communication terminals.

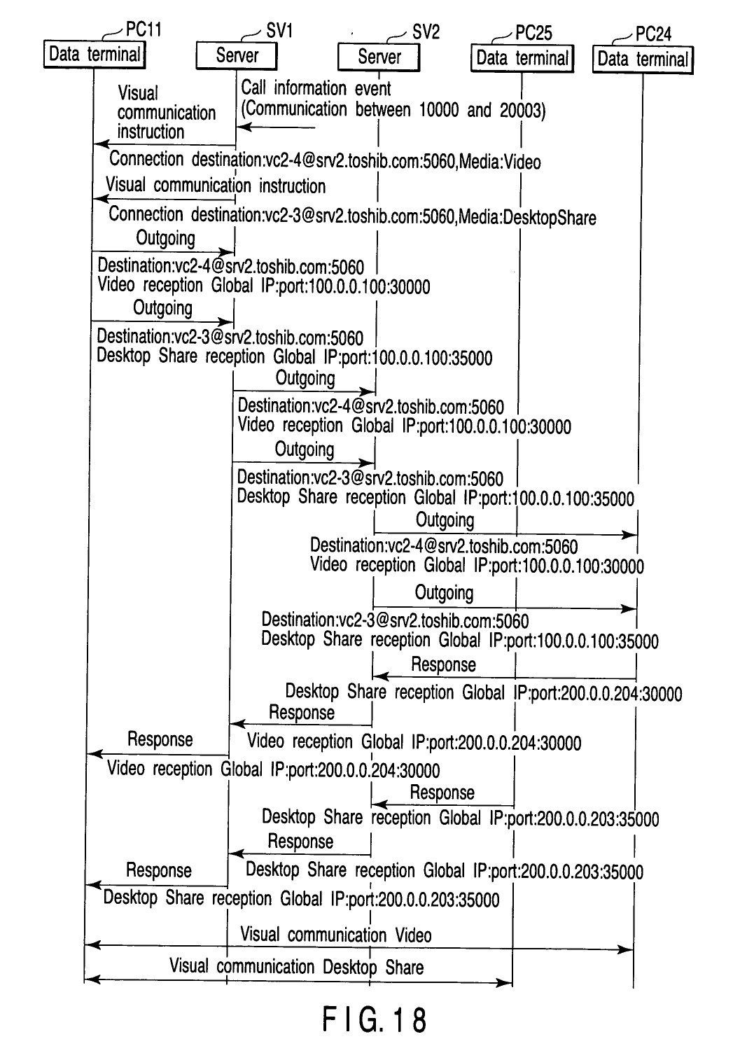

FIG. 17 is a schematic sequence view showing transmission/reception operations of information between one group consisting of the phone terminal T11, main apparatus BT1, VCS server SV1 and data terminal PC11 and the other group consisting of the phone terminal T24, main apparatus BT2, VCS server SV2 and data terminals PC24 and PC25, in performing visual communication control in the third embodiment. FIG. 18 is its detailed sequence view.

The data terminals PC24 and PC25 have registered ‘Desktop Share’ and ‘Video’ as communication media, respectively. The ‘Desktop Share’ means to share (screen-share) application software (for example, ‘Power Point’) on each Desktop by two sets of terminals to work cooperatively (for example, edit ‘Power Point’ by both terminals).

It is presumed that the user of the phone terminal T24 performs a dial operation for “10000” so as to make a communication with the user of the phone terminal T11. The phone terminal T24 then sends a communication establishment request signal to the main apparatus BT2. When receiving the request signal, the main apparatus BT2 transfers the request signal via the leased line PN1-2 to the main apparatus BT1 to have the main apparatus BT1 call the phone terminal T11 at the incoming destination. Then, in response to this, when the phone terminal T11 makes a response, a communication link is formed between the phone terminal T11 and the phone terminal T24.

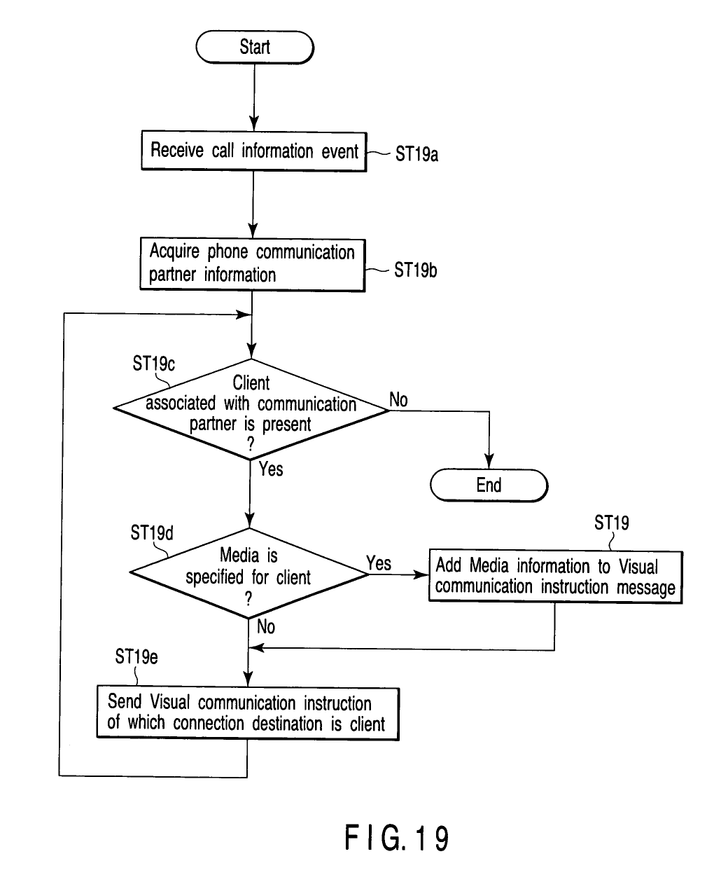

The VCS server SV1 then receives, as shown in FIG. 19, call information from the main apparatus BT1

an incoming side (block ST19a), acquires phone partner information (phone number) from the event (block Stl9b), and refers to the shared information management table 131 to determine whether or not the video communication terminal identifier associated with the acquired phone partner information (phone number)

the shared information management table 131. Here, the video communication terminal identifier “user1@srv1.toshib.com:5060” corresponding to the “10001” is present and the terminal identifiers “vc2-3@srv2.toshib.com:5060” and “vc2-4@srv2.toshib.com:5060” corresponding to “20003” are present, so that the sequence shifts from the block ST19c to a block ST19d and the VCS server SV1 refers to the individual information management table 132 to specify the data terminal PC11 on the basis of the IP address and port number corresponding to the terminal identifier “user1@srv1.toshib.com:5060”.

The VCS server SV1 then determines whether or not that the phone terminal T24 has specified any medium other than ‘Video’. If such a medium has not specified, the sequence shifts from the block ST19d to a block ST19e to issue a usual (here, for ‘Video’) visual communication instruction to the data terminal PC11. Here, having been specified, the VCS server SV1 makes a shift from the block ST19d to a block ST19f to send a visual communication instruction for ‘Video’ and a visual communication instruction for ‘Desktop Share’ to the data terminal PC11.

The data terminal PC12 which has received each visual communication instruction sends an outgoing message for ‘Video’ and an outgoing message for ‘Desktop Share’ to the VCS server SV1.

Since the IP addresses and port numbers corresponding to the “vc2-3@srv2.toshib.com:5060” and “vc2-4@srv2.toshib.com:5060” are not present in the VCS sever SV1, the VCS server SV1 transfers each outgoing message to the VCS server SV2 via the LAN 1.

When receiving each of the outgoing messages, the VCS server SV2 refers to the individual information management table 132 to determine whether or not the IP addresses and port numbers corresponding to the “vc2-3@srv2.toshib.com:5060” and “vc2-4@srv2.toshib.com:5060” are present. Here, they are present; the VCS server SV2 specifies the data terminals PC24 and PC25, based on the IP addresses and port numbers. At this time, the VCS server SV2 sends a response message to the VCS server SV1 via the LAN 1.

In response to this, when the VCS server SV1 receives the response message, sessions between the data terminal PC11 and each of the data terminals PC24 and PC25 are established.

Thus, the user of the phone terminal T24 becomes possible not only to automatically start a video communication but also a communication by means of other application software to and from the data-terminal PC11 by using the data terminals PC24 and PC25 only by operating the phone terminal T24.

In the third embodiment as given above, for connecting between the data terminal PC11 and PC24 and between the data terminal PC11 and PC25 for each kind of application software used in an arbitrary phone terminal T24 to perform a plurality of kinds of application software in parallel with one another, control of a plurality kinds of application software can be performed in linking with the call connections between the phone terminals T11 and T24 by registering the data terminals PC24 and PC25 to the VCS server SV2 for each kind of application software correspondingly to the phone terminal T24.

(Fourth Embodiment)

The fourth embodiment of the present invention relates to the above-mentioned data terminals PC11-PC1n and PC21-PC2r.

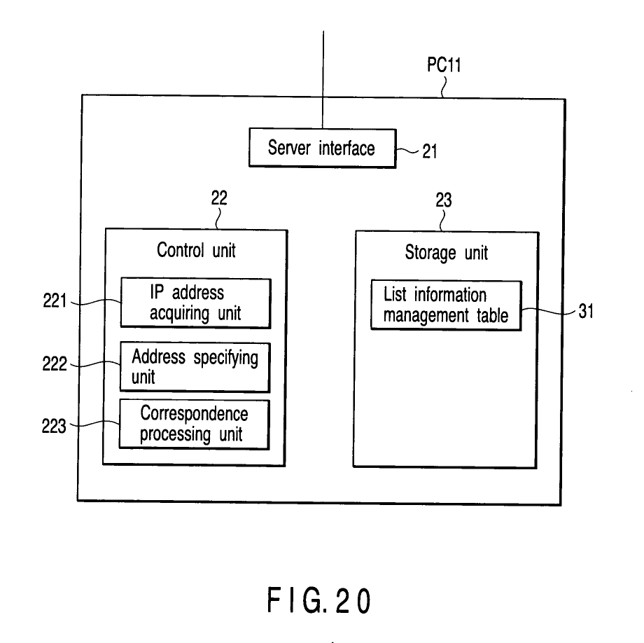

FIG. 20 is the block diagram showing functional configurations of the data terminals PC11-PC1n and PC21-PC2r in the fourth embodiment. Hereinafter, the data terminal PC11 will be described as a representative of the foregoing data terminals.

The data terminal PC11 comprises a server interface unit 21, a control unit 22 and a storage unit 23. Out of them, the server interface unit 21 conducts interface processing to and from the VCS server SV1.

The storage unit 23 is provided with a list information management table 231. The list information management table 231 stores address-mapped list information which has acquired from the NAT routers RT1 and RT2.

On the other hand, the control unit 22 has an IP address acquiring unit 221, an address specifying unit 222 and a correspondence processing unit 223 in addition to a control function to realize an operation as the data terminal PC11.

The IP address acquiring unit 221 acquires a Global IP address and a port number for a data reception included a payload section of an outgoing message to be received when a session is established.

The address specifying unit 222 determines whether or not a data communication between the data terminals is performed via the NAT router on the basis of the Global IP address and port number of the data reception included in the payload section acquired by the IP address acquiring unit 221. And if the data communication has made via the NAT router, the address specifying unit 222 specifies the Global address itself, and otherwise, it specifies the Local addresses itself.

When the address specifying unit 222 determined that the data communication between the data terminals is performed through the NAT router, the correspondence processing unit 223 makes the data terminal PC22 request for its own data reception Global IP and for a spare port to the NAT router and replies a response message by using the Global IP and the port number. Otherwise, the correspondence processing unit 223 makes the data terminal PC22 replies a response message by using its own data reception Local IP port and the port number.

Next to this, operations in the foregoing functional configuration will be described.

(Communication between Data Terminals under Different NAT Routers)

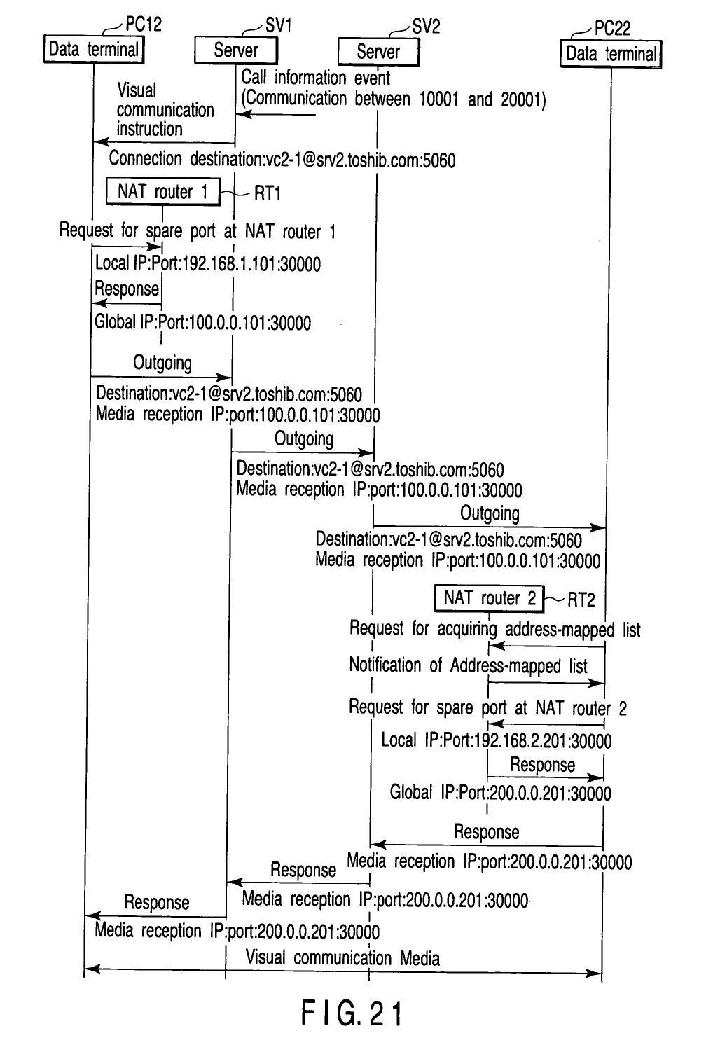

FIG. 21 a schematic sequence view showing transmission/reception operations of information between one group of the VCS server SVI and the data terminal PC12 and the other group of the VCS server SV2 and the data terminal PC22.

The VCS server SV1 receives the call information event from the main apparatus BT1 of a node on an incoming side, refers to the shared information management table 131 to determine the presence or absence of the video communication terminal identifier associated with the acquired phone partner information (phone number) in the shared information management table 131. Here, the video communication terminal identifier “user1-1@srv1.toshib.com:5060” corresponding to “10001” is present and the terminal identifiers “vc2-1@sev2.toshib.com:5060” corresponding to “20001” is present, so that the VCS server SV1 refers to the individual information management table 132 to specify the data terminal PC12 on the basis of the IP address and port number corresponding to the terminal identifier “user1-1@srv1.toshib.com:5060”. The VCS server SV1 then sends a visual communication instruction to the data terminal PC12.

The data terminal PC12, which has received the instruction, makes a spare port to be used for a media reception from the NAT router 1 RT1, sets the Global/Local IP: Port for the media reception and sends an outgoing message to the VCS server SV1.

The VCS server SV1 then receives the outgoing message from the data terminal PC12, acquires destination information included in the outgoing message, refers to the individual information management table 132 and determines whether the IP address and port number corresponding to the terminal identifier “vc2-1@srv2.toshib.com:5060” is present or not.

Here, the terminal identifier not being present, the VCS server SV1 transfers an outgoing message including the terminal identifier “vc2-1@sev2.toshib.com:5060” to the VCS server SV2 via the LAN 1.

When receiving the outgoing message, the VCS server SV2 refers to the individual information management table 132 to determine the presence or absence of the IP address and port number corresponding to the terminal identifier “vc2-1@sev2.toshib.com:5060”. Here, being present, the VCS server SV2 specifies the data terminal PC22 on the basis of the IP address and port number to send the outgoing message to the data terminal PC22.

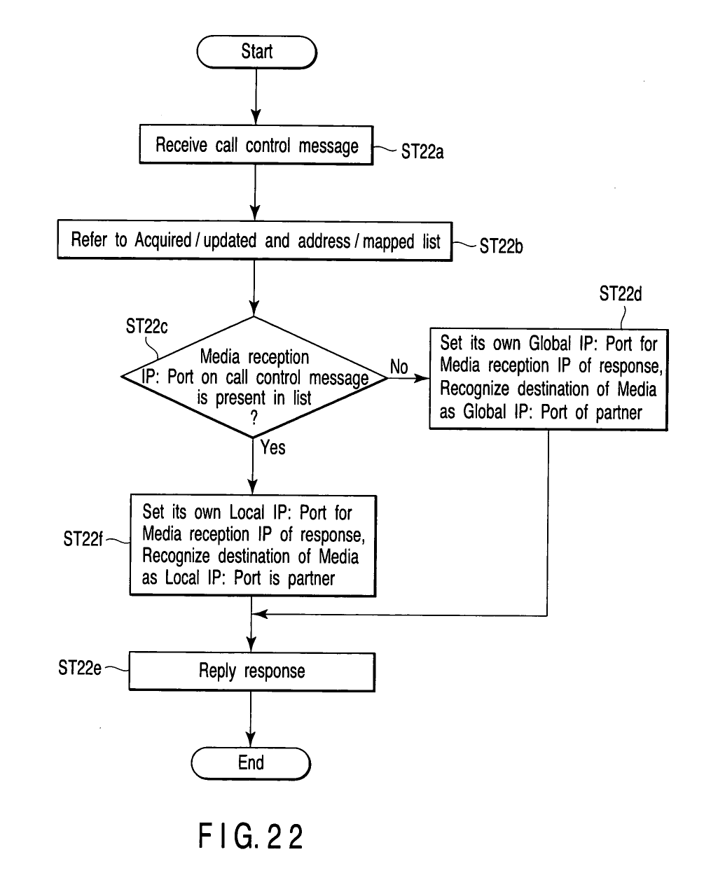

The data terminal PC22 then executes control processing shown in FIG. 22.

When the data terminal PC22 firstly receives the outgoing message (block ST22a), it issues an acquiring request for an address-already-mapped list to the NAT router 2 RT2 and receives to refer to the list information sent from the NAT router 2 RT2 in response to the acquiring request (block ST22b).

The data terminal PC22 then checks if the Media reception IP: Port (Global IP: Port) on the received outgoing message is present in the acquired list (block ST22c). In this case, the Media reception IP: Port on the outgoing message is “100.0.0.101.30000” and the address mapping with respect thereto is “Global IP: Port: 100.0.0.101:30000” and “Local IP: Port: 192.168.1.101:30000”; however these addresses are not registered in the NAT router 2 RT2 but in the NAT router 1 RT1, so that they are not present in the list acquired from the NAT router 2 RT2.

The data terminal PC22 then shifts from the block ST22c to a block ST22d, determines that outgoing origins are not under the same NAT, requests its own Global IP: Port to make a reply through a response message (block ST22e). And the data terminal PC22 recognizes that the ‘Media’ should be sent to Media reception IP: Port on the received outgoing message (block ST22f).

The VCS server SV2 then sends a response message to the VCS server SV1 via the LAN 1.

In response to this, if the VCS server SV1 receives the response message, the session between the data terminal PC12 and data terminal PC22 is established.

Thus, the user of the phone terminal T22 becomes possible to automatically start the video communication with the data terminal PC12 by using the data terminal PC22 only by operating the phone terminal 22.

(Communications between Data Terminals under the same NAT router)

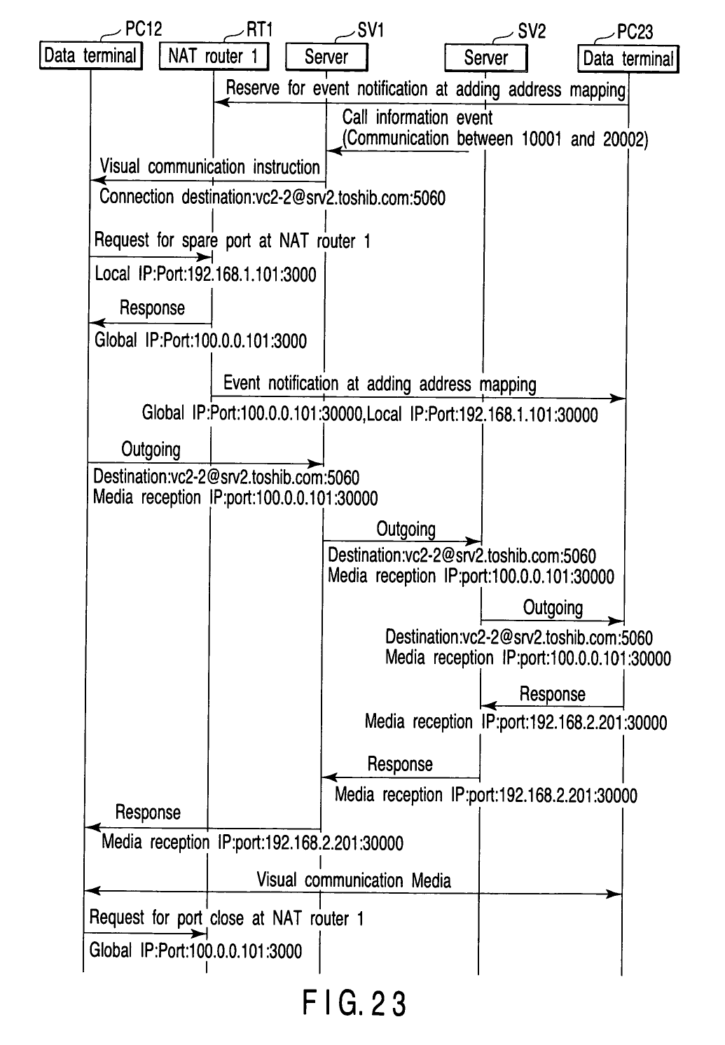

FIG. 23 is a schematic sequence view showing transmission/reception operations of information between one group of VCS server SV1 and the data terminal PC12 and the other group of the server SV2 and the data terminal PC23. In this sequence, a system is employed, by which it is reserved in advance that the fact of an addition of mapping should be notified at that time of the addition from the NAT router 1 RT 1.

The VCS server SV1 receives the call information event from the main apparatus BT1 of the node on the incoming side, refers to the shared information management table 131 and determines whether or not the video communication terminal identifier associated with the acquired phone partner information (phone number) is present. Here, the terminal identifier “user1-1@srv1.toshib.com:5060” corresponding to “10001” is present and the terminal identifier “vc2-2@srv2.toshib.com:5060” corresponding to “20002” is also present, so that the VCS server SV1 refers to the individual information management table 132 to specify the data terminal PC12 on the basis of the IP address and port number corresponding to the terminal identifier “user1-1@srv1.toshib.com:5060”. And the VCS server SV1 sends a visual communication instruction to the data terminal PC12.

The data terminal PC12 which has received the communication instruction makes a spare port for use in a media reception from the NAT router 1 RT1 and sets a Global IP: Port for the media reception to send an outgoing message to the VCS server SV1.

The VCS server SV1 then receives the outgoing message from the data terminal PC12 to acquire destination information included in the outgoing message, and refers to the individual information management table 132 to determine whether or not the IP address and port number corresponding to the terminal identifier “vc2-2@srv2.toshib.com:5060” are present.

Not having been present here, the VCS server SV1 transfers an outgoing message including the terminal identifier “vc2-2@srv2.toshib.com:5060” to the server SV2 via the LAN 1.

When receiving the outgoing message, the VCS server SV2 refers to the individual information management table 132 to determine whether or not the IP address “100.0.0.102” and the port number “15000” corresponding to the terminal identifier “vc2-2@srv2.toshib.com:5060” are present. Having been present here, the VCS server SV2 specifies the data terminal PC23 on the basis of the IP address and port number and sends an outgoing message to the data terminal PC23.

The data terminal PC23 which has received the outgoing message checks if Media reception IP: Port (Global IP: Port) on the received outgoing message is present in the updated list. At this time, the Media reception IP: Port on the outgoing message is “100.0.0.101:30000” and the address mapping in relation to this is Global IP: Port: 100.0.0.101:30000 and Local IP: Port: 192.168.1.101:30000 and these addresses have been registered in the NAT router 1 RT1, so that they are present in the list required by the data terminal PC23 from the NAT router 1 RT1.

Here, the data terminal PC23 makes a shift from the block ST22c to the block ST22f, determines that the outgoing origins are under the same NAT and replies its own Local IP: Port together with a response message. And the data terminal PC23 recognizes that the ‘Media’ should not be transmitted to Media reception IP: Port on the received outgoing message but it should be transmitted to Local IP: Port “192.168.1.101:30000” corresponding to the Media reception IP: Port.

In response to this, when the VCS server SV1 receives the response message, the session between the data terminal PC12 and the data terminal PC23 is established.

The user of the phone terminal T23 thus becomes possible to automatically start the video communication to and from the data terminal PC12 by using the data terminal PC23 only by operating the phone terminal 23.

As mentioned above, in the fourth embodiment, it is configured for each data terminal PC11-PC1n and PC21-PC2r to execute correspondence processing in regard to excess of capacities of the NAT routers RT1 and RT2.

Therefore, the VCS in this embodiment can utilize the existing VCS servers as they are without having to adding any new function to the VCS servers SVI and SV2. Thereby, the VCS can suppress costs of the whole of the VCS as much as possible and perform the data communication connection between the associated data terminals PC12 and PC22 in linking with the call connection between the data terminals PC12 and OC22.

(Other Embodiments)

The present invention is not limited to the above-described embodiments. For instance, the second embodiment having expressed the session establishment between data terminals belonging to the different NAT routers and also the session establishment between data terminals belonging to the same NAT router; however, it is our intention that the invention is not limited to the second embodiment, and this invention can be embodied in such a manner to establish a session between the data terminals belonging the NAT router and those not belonging the NAT router.

The third embodiment having presented an example simultaneously starting up the data terminal for the ‘Desk Share’ and the data terminal for the ‘Video’, the data terminals may be started up by means of other application software.

Aforementioned each embodiment having described the example connecting each main apparatus though the leased lines, the invention is not limited to the embodiments, each main apparatus may be connected by a communication network other than IP exclusive lines.

Other than this, with respect to a configuration and a type of a VCS server, a type of an phone exchange apparatus (not limited to a main apparatus but may be a PBX), a type of a phone terminal, a type of a data terminal, a storage content of each table, a method for controlling a session between data terminals, etc., may be achieved by modifying in a variety of types without departing from the scope of the present invention.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalens are intended to cover such forms or modifications as would fall within the scope and spirit of the inventions.

What is claimed is:

1. A communication system, comprising:
a first server apparatus to receive call information indicating call states of a plurality of phone terminals from at least one telephone exchange among a plurality of telephone exchanges executing exchange processing among a plurality of phone terminals, and link data communication connections at data terminals associated respectively with the plurality of phone terminals;
a second server apparatus which is connected to the first server apparatus via a communication network and has the same function as that of the first server apparatus;
a first memory which is commonly provided for the first and the second server apparatuses and stores a first management table associating first identification information assigned to the plurality of phone terminals, third information to become at least a part of items of second identification information assigned to a plurality of phone terminals belonging to the first server apparatus and third identification information to become at leas a part of items of second identification information assigned to a plurality of data terminals belonging to the second server apparatus with one another;
a second memory which is provided for the first server apparatus and stores a second management table associating the third identification information belonging to the first server apparatus with fourth identification information to become information deferent from the third identification information out of the second identification information;
a third memory which is provided for the second server apparatus and stores a third management table associating the third identification information belonging to the second server apparatus with the fourth identification information; and
a controller which refers to the third identification information corresponding to a phone terminal of a request origin from the first management table, and connects among data terminals corresponding respectively to a plurality of phone terminals to be connected, based on the referred third identification information and fourth identification information corresponding to the third identification information stored in at least one of the second and the third management tables, in the first and the second server apparatuses in occurring a connection request.

2. The communication system according to claim 1, wherein
the third identification information includes information identifying the first and the second server apparatuses to identify the data terminals belonging to the first and the second server apparatuses; and
the fourth identification information is address information and port information.

3. The communication system according to claim 1, wherein
the second memory stores the second management table associating the third identification with the fourth identification information for each kind of application software usable at the data terminals; and
the controller refers to the second management table and controls connections among the data terminals for each kind of application software on the basis of the third and the fourth identification information, when a data terminal associated with a phone terminal at a request origin belongs to the first server apparatus.

4. The communication system according to claim 1, wherein
the third memory stores the third management table associating the third identification information with the fourth identification information, for each kind of application software usable at the data terminals; and
the controller refers to the third management table and controls connections among the data terminals, for each kind of application software on the basis of the third and the fourth identification information, when a data terminal associated with a phone terminal at a request origin belongs to the second server apparatus.

5. A server apparatus which receives call information indicating call states of a plurality of phone terminals from a telephone exchange executing exchange processing of the plurality of phone terminals, and makes data communication connections among a plurality of data terminals associated respectively with the plurality of phone terminals in linking with the call states, comprising:
an acquiring unit to acquire more than one items of data reception address information included in a data area of a message from each data terminal in connecting the data terminals with one another;
a specifying unit to specify address information to receive a data communication based on the data reception address information and address information of a destination of the message; and
a notifying unit to notify instruction information to instruct that the address information should be used for the data communication to the data terminal.

6. A data terminal apparatus which are associated respectively with a plurality of phone terminals and performed data communication connections in linking with call states, by a server apparatus which receives call information of call states of the plurality of phone terminals by a telephone exchange apparatus executing exchange processing among the plurality of phone terminals, comprising:
an acquiring unit to acquire one or more items of data reception address information included in a data area of a received message, in connecting;
a specifying unit to specify address information receiving a data communication on the basis of the data reception address information and its own address information used for receiving the message; and
a transmitter which replies a message on the basis of the specified address information.

7. The data terminal apparatus according to claim 6, further comprising:
a memory which stores list information in relation to a Global IP and a port number, and a Local IP and a port number which are mapped to a network address translator (NAT) router, wherein
the transmitter specifies address information receiving a data communication in accordance with whether or not the data receiving address is included in the list information to reply the message.

8. A server apparatus which receives call information indicating call states of a plurality of phone terminals from a telephone exchange executing exchange processing of the plurality of phone terminals, and links data communication connections of a plurality of data terminals associated respectively with the plurality of phone terminals, comprising:
a memory which stores a management table associating first identification information assigned to the plurality of phone terminals with second identification information assigned to the plurality of data terminals, for each application software usable at the data terminals; and
a controller which refers to the management table in occurring a connection request specifying application software, and connects among data terminals on the basis of the first and the second identification information corresponding to the specified application software.
